(19) United States
(12) Patent Application Publication
(10) Pub. No.: US 2005/0272603 A1
(43) Pub. Date: Dec. 8, 2005

(54) Color developer and thermal recording material containing the same

(76) Inventors: Fumio Oi, Wakayama (JP); Norio Yanase, Wakayama (JP); Nobuyuki Nate, Wakayama (JP)

Correspondence Address: HARNESS, DICKEY & PIERCE, P.L.C., P.O. BOX 8910, RESTON, VA, 20195, US

(21) Appl. No.: 10/528,784

(22) PCT Filed: Sep. 22, 2003
(86) PCT No.: PCT/JP03/12071

§ 371 Date: Mar. 23, 2005

(30) Foreign Application Priority Data
Sep. 24, 2002 (JP) 2002-278018

(51) Int. Cl. B41M 5/30

(52) U.S. Cl. 503/216

(57) ABSTRACT

A thermal recording material includes a thermosensitive coloring layer, which is made by applying a dispersion liquid, in which the developer and a coloring dye are dispersed, onto a supporting base, and then drying the base. The developer contains 4,4′-dihydroxydiphenyl sulfone as a major component; and 2,4′dihydroxydiphenyl sulfone, the 4,4′-dihydroxydiphenyl sulfone and the 2,4′-dihydroxydiphenyl sulfone being contained at a weight ratio greater than 90:10 and no more than 100:0, and the developer containing phenolsulfonic acid phenyl ester no more than 1.5% by weight with respect to a sum quantity of the 4,4′-dihydroxydiphenyl sulfone and the 2,4′-dihydroxydiphenyl sulfone. The present invention thus provides a thermal recording material causing less surface texture fogging and is superior in preservation ability, and also provides a developer suitably used as a component of the thermal recording material.

### TECHNICAL FIELD

The present invention relates to a developer containing in major proportions either 2,4′-dihydroxydiphenyl sulfone or 4,4′-dihydroxydiphenyl sulfone, and also relates to a thermal recording material containing the developer.

### BACKGROUND ART

A thermal recording paper (thermal recording material) including a thermosensitive coloring layer, made of a developer and a coloring dye, has conventionally been used as a recording paper (output paper) for various devices, for example, an information communication device such as a facsimile, or an information recording device such as a printer. Meanwhile, there have been various demands for the thermal recording material, for example, high coloring sensitivity (coloring property), high fastness (causing less degradation with time) of a colored image and the background (a portion where the colored image is not formed), that allows the paper to be preserved for a long period of time.

In view of these demands, for example, Japanese Laid-Open Patent Application Tokukaisho 57-150599/1982 (published on Sep. 17, 1982) and Japanese Laid-Open Patent Application Tokukaisho 63-3991/1988 (published on Jan. 8, 1988) disclose developers made of 2,4′-dihydroxydiphenyl sulfone or 4,4′-dihydroxydiphenyl sulfone that allow steady preservation of the colored image and the background, as a developer with superior preservation stability.

The developers of the foregoing publications, that achieve superior preservation stability for a colored image and the background, is however poor in coloring sensitivity. Further, its preservation stability of the colored image is yet insufficient.

Meanwhile, for example, Japanese Laid-Open Patent Application Tokukai 2001-260544/2001 (published on Sep. 25, 2001) and Japanese Laid-Open Patent Application Tokukai 2001-293964/2001 (published on Oct. 23, 2001) disclose developers using mixture of 4,4′-dihydroxydiphenyl sulfone and 2,4′-dihydroxydiphenyl sulfone, as well as a thermal recording material having a thermosensitive coloring layer containing the developer and a sensitizer.

Further, Japanese Laid-Open Patent Application Tokukai 2002-120462/2002 (published on Apr. 23, 2002) discloses a thermal recording material with a thermosensitive coloring layer containing a developer created by mixing 4,4′-dihydroxydiphenyl sulfone and 2,4′-dihydroxydiphenyl sulfone at a specific ratio.

However, the thermal recording materials disclosed in Japanese Laid-Open Patent Application Tokukai 2001-260544/2001 and Japanese Laid-Open Patent Application Tokukai 2001-293964/2001 are poor particularly in whiteness of background (causing so-called texture fogging), and are insufficient in preservation stability (that is, insufficient in moisture and heat resistance, water-resistance, plasticizer-resistance and heat-resistance). Further, the thermal recording material disclosed in Japanese Laid-Open Patent Application Tokukai 2002-120462/2002 is sufficient in plasticizer-resistance, but is not satisfactorily improved to overcome the defect of texture fogging.

Under such circumstances, the current demand is creation of a thermal recording material with sufficiently reduced texture fogging and a superior preservation stability, and a developer for producing such a thermal recording material.

The present invention is made in view of the foregoing conventional problems, and the main object is to provide a thermal recording material causing less texture fogging and having a superior preservation property, such as moisture and heat resistance or water-resistance (so-called weatherability); and a developer suitably used as a component of the thermal recording material.

### DISCLOSURE OF INVENTION

In order to attain the foregoing object, the inventors of the present invention worked on intensive researches; and they have found that, although the mechanism (causal connection) is not clearly known, there is a correlation between the content of phenolsulfonic acid phenyl ester, that is an impurity contained in 2,4′-dihydroxydiphenyl sulfone or 4,4′-dihydroxydiphenyl sulfone, and the degree of generation of texture fogging of a thermal recording material using a developer that includes the compound containing the impurity. Further, on the basis of the foregoing discovery that had never been conventionally known, the inventors practically confirmed that the thermal recording material containing phenolsulfonic acid phenyl ester at or less than a certain proportion causes less surface texture fogging and is superior in preservation stability. With this embodiment, they completed the present invention.

In order to attain the foregoing object, a developer of the present invention contains 2,4′-dihydroxydiphenyl sulfone as a major component; and 4,4′-dihydroxydiphenyl sulfone, the 2,4′-dihydroxydiphenyl sulfone and the 4,4′-dihydroxydiphenyl sulfone being contained at a weight ratio greater than 90:10 and no more than 100:0, and the developer containing phenolsulfonic acid phenyl ester no more than 1.5% by weight with respect to a sum quantity of the 2,4′-dihydroxydiphenyl sulfone and the 4,4′-dihydroxydiphenyl sulfone.

In order to attain the foregoing object, a developer of the present invention contains 4,4′-dihydroxydiphenyl sulfone as a major component; and 2,4′-dihydroxydiphenyl sulfone, the 4,4′-dihydroxydiphenyl sulfone and the 2,4′-dihydroxydiphenyl sulfone being contained at a weight ratio greater than 90:10 and no more than 100:0, and the developer containing phenolsulfonic acid phenyl ester no more than 1.5% by weight with respect to a sum quantity of the 4,4′-dihydroxydiphenyl sulfone and the 2,4′-dihydroxydiphenyl sulfone.

With the foregoing arrangement, the developer contains phenolsulfonic acid phenyl ester no more than 1.5% by weight with respect to a sum quantity of the 2,4′-dihydroxydiphenyl sulfone and the 4,4′-dihydroxydiphenyl sulfone. Thus, it is possible to provide a developer suitably used as a component of a thermal recording material causing less surface texture fogging and is superior in preservation stability.

In order to attain the foregoing object, a dispersion liquid of the present invention is arranged so that the foregoing developer and a coloring dye are dispersed in a dispersion medium. Thus, it is possible to provide a dispersion liquid containing a developer suitably used as a component of a thermal recording material causing further less surface texture fogging and is further superior in preservation stability.

In order to attain the first object, a thermal recording material of the present invention includes a thermosensitive coloring layer that contains a developer and a coloring dye on a supporting base, wherein the developer contains 2,4′-dihydroxydiphenyl sulfone as a major component; and 4,4′-dihydroxydiphenyl sulfone, the 2,4′-dihydroxydiphenyl sulfone and the 4,4′-dihydroxydiphenyl sulfone being contained at a weight ratio greater than 90:10 and no more than 100:0, and the developer containing phenolsulfonic acid phenyl ester no more than 1.5% by weight with respect to a sum quantity of the 2,4′-dihydroxydiphenyl sulfone and the 4,4′-dihydroxydiphenyl sulfone.

In order to attain the first object, a thermal recording material of the present invention includes a thermosensitive coloring layer that contains a developer and a coloring dye on a supporting base, wherein the developer contains 4,4′-dihydroxydiphenyl sulfone as a major component; and 2,4′-dihydroxydiphenyl sulfone, the 4,4′-dihydroxydiphenyl sulfone and the 2,4′-dihydroxydiphenyl sulfone being contained at a weight ratio greater than 90:10 and no more than 100:0, and the developer containing phenolsulfonic acid phenyl ester no more than 1.5% by weight with respect to a sum quantity of the 4,4′-dihydroxydiphenyl sulfone and the 2,4′-dihydroxydiphenyl sulfone.

With the foregoing arrangement, the developer contains phenolsulfonic acid phenyl ester no more than 1.5% by weight with respect to a sum quantity of the 2,4′-dihydroxydiphenyl sulfone and the 4,4′-dihydroxydiphenyl sulfone. Thus, it is possible to provide a developer suitably used as a component of a thermal recording material causing further less surface texture fogging and is further superior in preservation stability.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1 is a graph showing a relation between the content of phenolsulfonic acid phenyl ester, that is an impurity contained in the developer, and the coloring depth of the background.

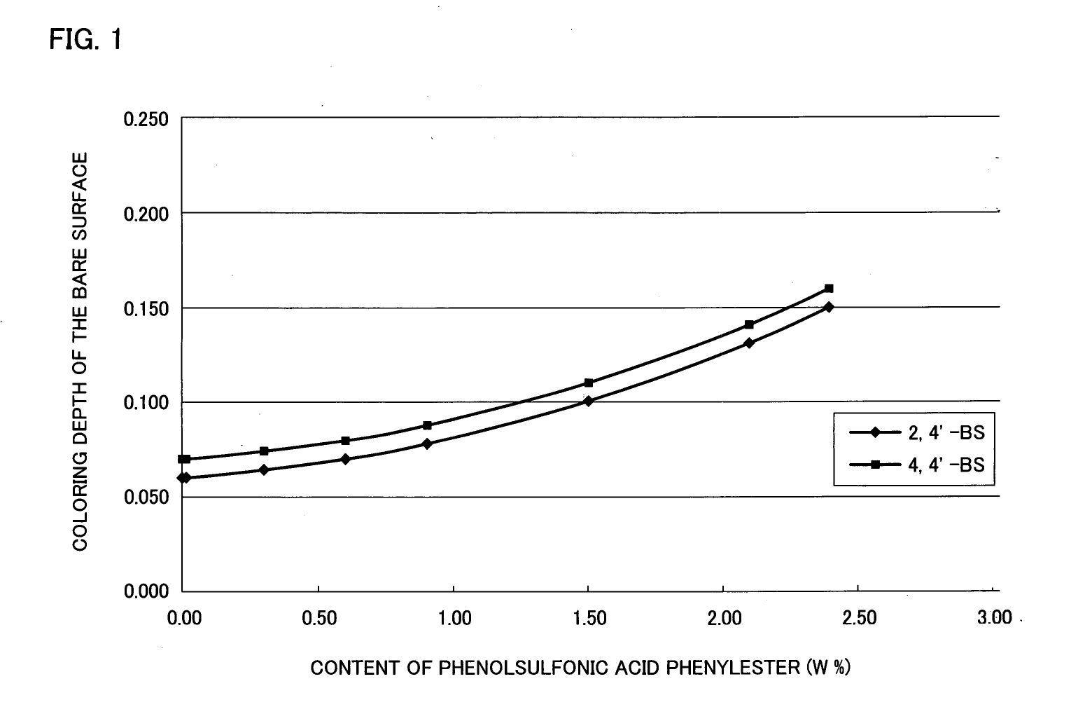

### BEST MODE FOR CARRYING OUT THE INVENTION

One embodiment of the present invention is described below.

A thermal recording material according to the present invention includes a supporting base that has a thermosensitive coloring layer containing a developer and a coloring dye. The developer contains 2,4′-dihydroxydiphenyl sulfone [HO—C₆H₄—SO₂—C₆H₄—OH (2,4′-bisphenol S)] as a major component; and 4,4′-dihydroxydiphenyl sulfone [HO—C₆H₄—SO₂—C₆H₄—OH (4,4′-bisphenol S)], the 2,4′-dihydroxydiphenyl sulfone and the 4,4′-dihydroxydiphenyl sulfone being contained at a weight ratio greater than 90:10 and no more than 100:0, and the developer containing phenolsulfonic acid phenyl ester no more than 1.5%, more preferably no more than 1.0% by weight, with respect to a sum quantity of the 2,4′-dihydroxydiphenyl sulfone and the 4,4′-dihydroxydiphenyl sulfone; otherwise, the developer contains 4,4′-dihydroxydiphenyl sulfone as a major component; and 2,4′-dihydroxydiphenyl sulfone, the 4,4′-dihydroxydiphenyl sulfone and the 2,4′-dihydroxydiphenyl sulfone being contained at a weight ratio greater than 90:10 and no more than 100:0, and the developer containing phenolsulfonic acid phenyl ester no more than 1.5%, more preferably no more than 1.0% by weight, with respect to a sum quantity of the 4,4′-dihydroxydiphenyl sulfone and the 2,4′-dihydroxydiphenyl sulfone.

The phenolsulfonic acid phenyl ester [HO—C₆H₄—SO₃—C₆H₅) is a compound, that is an impurity resulting from manufacturing of the 2,4′-dihydroxydiphenyl sulfone, and/or of the 4,4′-dihydroxydiphenyl sulfone. The phenolsulfonic acid phenyl ester contains three types of isomer: ortho-type, meta-type and para-type, depending on the substitution position of the OH group.

The content of the phenolsulfonic acid phenyl ester with respect to the sum of the 2,4′-dihydroxydiphenyl sulfone and the 4,4′-dihydroxydiphenyl sulfone can be measured by a high-performance liquid chromatography (HPLC), for example. One example of the measurement method (analysis condition) is shown below.
Column: YMC-Pack ODS-A312 (6.0φ×150 mm)
Mobile phase: 0.05M-KH₂PO₄/acetonitrile=50/50
Flow rate: 1.0 ml/min.
Detector: UV 254 nm
Elution time:
4,4′-dihydroxydiphenyl sulfone=approximately 4 minutes
2,4′-dihydroxydiphenyl sulfone=approximately 4.5 minutes
phenolsulfonic acid phenyl ester=approximately 9 minutes

The foregoing measurement is represented as a chart, that allows calculation of the content (% by weight) of phenolsulfonic acid phenyl ester with respect to the sum of the 2,4′-dihydroxydiphenyl sulfone, and the 4,4′-dihydroxydiphenyl sulfone.

As disclosed in Japanese Patent Publication Tokukouhei 07-119195/1995 and Japanese Laid-Open Patent Application Tokukaihei 10-25277/1998, the mixture of 4,4′-dihydroxydiphenyl sulfone and 2,4′-dihydroxydiphenyl sulfone (hereinafter referred to simply as a mixture including the case where the proportion of one of them=0) may be inexpensively produced by dehydrating reaction of a phenol and a sulfonation agent, p-phenolsulfonic acid, and/or o-phenolsulfonic acid; otherwise, by dehydrating reaction of a phenol and a sulfuric acid as a sulfonation agent. The condition for reaction, such as reaction temperature, reaction time etc. are not particularly limited, and may be appropriately set to an arbitrary value ensuring completion of the reaction.

After the dehydrating reaction, the mixture is extracted through crystallization, filtration, drying etc. The obtained mixture is further subjected to purification as required through solvent (extraction) processing, crystallization, filtration, decolorization, recrystallization etc., so that 2,4′-dihydroxydiphenyl sulfone and 4,4′-dihydroxydiphenyl sulfone are separated from each other. These isolated compounds are mixed at an appropriate ratio to have the desired proportion, that is, a ratio of one compound to the other is greater than 90:10 and no more than 100:0 by weight. On this account, apart from the mixture extracted from the reaction solution through the foregoing processes, the definition of “mixture” of the present invention also includes a mixture obtained by adding more 4,4′-dihydroxydiphenyl sulfone or more 2,4′-dihydroxydiphenyl sulfone to the extracted mixture to create a mixture with other proportion, or a mixture obtained by mixing the isolated compound of 4,4′-dihydroxydiphenyl sulfone and the isolated compound of 2,4′-dihydroxydiphenyl sulfone at the foregoing ratio.

Here, with reference to Figure (graph) 1, the following describes a correlation between the content (% by weight) of phenolsulfonic acid phenyl ester with respect to the mixture and degree of texture fogging of the surface of a thermal recording material containing the mixture as a developer. The horizontal axis of the graph denotes the content (% by weight) of phenolsulfonic acid phenyl ester calculated by the measurement method with HPLC, and the vertical axis denotes a coloring depth of the bare surface of the material, measured with a dynamic coloring test (described later). In the graph, a lower coloring depth indicates a lower degree of texture fogging. More specifically, a coloring depth of not more than 0.12, more preferably not more than 0.10 can be a proof of sufficient reduction of the texture fogging, meaning that the quality of the material is improved.

As can be seen in the graph, when the content of phenolsulfonic acid phenyl ester is no more than 1.5% by weight with respect to the mixture, the coloring depth of the background falls at or below 0.12; further, when the contents of phenolsulfonic acid phenyl ester is 1.0% by weight or less with respect to the mixture, the coloring depth of the background falls at or below 0.10.

Accordingly, it is required that the content of phenolsulfonic acid phenyl ester with respect to the mixture is no more than 1.5% by weight. The content of phenolsulfonic acid phenyl ester may be adjusted during manufacturing of the mixture by performing general various purification processes, that are commonly performed industrially, such as solvent extraction, crystallization, filtration, decolorization, recrystallization etc. This means, the preparation method is not particularly limited. A suitable solvent used in the solvent (extraction) processing may be a mixture solvent of 1,2-dichlorobenzene and a phenol.

Consequently, obtained is a developer suitably used as a component of a thermal recording material, with less texture fogging and a superior preservation stability. More specifically, the foregoing method provides a developer suitably used as a component of a thermal recording material having a superior preservation property (moisture and heat resistance, water-resistance, plasticizer-resistance and heat-resistance) for both the colored image and the background texture, as well as high coloring sensitivity and superior whiteness of the background.

Further, the developer containing the foregoing mixture as a main component may be dispersed on a dispersion medium together with a coloring dye, so as to form a thermosensitive coloring layer by applying the dispersion liquid on a supporting base, and drying the supporting base. In this way, a thermal recording material made up of a supporting base having a thermosensitive coloring layer including a developer and a coloring dye is created.

As a specific example of the coloring dye, it may be a fluorane dye, such as 3-(N,N-diethylamino)-6-methyl-7-anilino fluorane, 3-(N,N-di-n-butylamino)-6-methyl-7-anilino fluorane, 3-[N-ethyl-N-(isobutyl)amino]-6-methyl-7-anilino fluorane, 3-(N,N-dipentylamino)-6-methyl-7-anilino fluorane, 3-(N,N-di-n-butylamino)-6-methyl-7-(o-chloroanilino) fluorane, 3-(N,N-di-n-butylamino)-7-(o-chloroanilino) fluorane, 3-[N-ethyl-N-(p-tolyl)amino]-6-methyl-7-anilino fluorane; a triarylmethane dye, such as 3,3-bis (p-dimethylaminophenyl)-6-dimethyl amino phthalide, 3-(p-dimethylaminophenyl)-3-(2-phenyl-3-indolyl) phthalide, 3-(p-dimethylaminophenyl)-3-(1,2-dimethyl-3-indolyl) phthalide, 3,3-bis (9-ethyl-3-carbazolyl)-5-dimethyl amino phthalide, 3,3-bis (2-phenyl-3-indolyl)-5-dimethyl amino phthalide; a diphenylmethane dye such as 4,4′-bisdimethyl amino benzhydride benzyl ether; a thiazine dye (phenothiazine dye), such as benzoyl leucomethylene blue; a spiro dye (spiropyrane dye), such as 3-methyl dinaphtho spiro pyran; or a leuco dye, such as a lactam dye, leuco auramine dye, indoline dye, indigo dye etc. However, the dye is not limited to those but may be any kind as long as it exhibits no color or a hypochromic color under normal temperature, and exhibits a color when reacted with the acid developer by heat application. The present invention allows the use of one or a plurality of those coloring dyes.

In the present invention, the ratio of the mixture with respect to the developer is preferably not less than 0.95% by weight. The other component (compound) of the developer than the mixture may be, for example, a phenolic compound, such as p-octyl phenol, p-t-butyl phenol, p-phenyl phenol, p-hydroxy acetophenone, α-naphthol, p-the third octyl catechol, 2,2′-dihydroxy biphenyl, 1,1-bis (p-hydroxy phenyl) butane, 2,2-bis (4-hydroxy phenyl) propane, 2,2-bis (3-methyl-4-hydroxy phenyl) propane, 2,2-bis (3,5-dimethyl-4-hydroxy phenyl) propane, 2,2-bis (3,5-dichloro-4-hydroxy phenyl) propane, bis (3-allyl-4-hydroxy phenyl) sulfone, bis (3,4-dihydroxy phenyl) sulfone, 1,1-bis (4-hydroxy phenyl) cyclohexane, bis (4-hydroxy phenyl ether) bis [2-(4-hydroxy phenylthio) ethoxy]methane, 4-(4-isopropoxy benzenesulfonyl) phenol, 4-hydroxy dimethyl phthalate, bis (4-hydroxy phenyl) butyl acetate, p-hydroxy benzyl benzoate, 3,5-di-t-butyl salicylic acid; an aromatic carboxylic acid, such as benzoic acid, phthalic acid, zinc salycylate; or an aromatic carboxylic acid metallic salt, such as salicylic acid zinc. However, the compound is not limited to those but may be any kind as long as it reacts with the coloring dye by heat. The present invention allows the use of one or a plurality of those compounds.

The amount of the developer is not restricted and may be appropriately decided according to the type of the coloring dye and the developer and/or combination of them. However, the amount of developer is preferably 0.5 to 0.6 part by weight, more preferably 1 to 2.5 parts by weight, with respect to 1 part coloring dye.

The dispersion medium is not limited to the foregoing example and may be any compound allowing dispersion of the developer and the coloring dye. However, a preferable example is so-called a water-soluble binder, such as polyvinyl alcohol, latex or methyl cellulose.

The dispersion liquid may also contain a sensitizer. In other words, the thermosensitive coloring layer formed from the dispersion liquid may contain a sensitizer as required so as to improve coloring sensitivity. However, the amount of the sensitizer should be controlled not to degrade various required functions of a thermal recording material. The sensitizer is preferably a compound having a melting point of 50-150° C. A specific example may be a nitrogen compound, such as stearamide, palmitamide, linoleamide, stearamide; an ester compound, such as benzyl 4-hydroxybenzoate, benzyl 4-benzyloxybenzoate, 2-naphthoic acid phenyl ester, benzyl 2-naphthoate, 1-hydroxy-2-naphthoic acid phenyl ester, dibenzyl oxalate, di (4-methylbenzyl oxalate, dibenzyl terephthalate, n-butyl isophthalate, p-toluenesulfonic acid phenyl ester; an aromatic compound, such as 4-benzyl biphenyl, m-terphenyl, 1,2-bis (3,4-dimethylphenyl) ethane, 1,2-bis (2,4-dimethylphenyl) ethane, 1,2-bis (2,4,5-trimethylphenyl) ethane; an ether compound or a sulfur compound, such as 2-benzyloxynaphthalene, 1,4-diethoxynaphthalene 1,2-diphenoxyethane, 1,2-diphenoxybenzene, 1,4-diphenoxybenzene, 4-(4′-methylphenoxy)biphenyl, diphenyl sulfone, 4-methyldiphenyl sulfone, 4,4′-diisopropoxydiphenyl sulfone, 4,4′-diphenoxydiphenyl sulfide, benzyl-4-methyl phenyl sulfide, 1,2-bis (phenoxymethyl) benzene; or 4-acetyl biphenyl. However, the compound is not limited to those. The present invention allows the use of one or a plurality of these compounds according to the needs. The amount of the sensitizer with respect to the developer or to the coloring dye is not particularly restricted.

Further, as required, the dispersion liquid may also contain an additive, such as: a white pigment such as calcium carbonate; a filling material such as kaolin, clay; a dispersion adjuvant; an oxidation inhibitor; preservation stabilizer; an antifoaming agent. More specifically, in view of improvement of various performances and easy handling, the thermosensitive coloring layer formed from the dispersion liquid may contain those additives as required. However, the amount of the sensitizer should be controlled not to degrade various required functions of a thermal recording material. The amount of the sensitizer with respect to the developer or to the coloring dye is not particularly restricted.

Further, as required, in addition to the thermosensitive coloring layer, the thermal recording material may also include an undercoat layer such as a heat-insulating layer, or an overcoat layer such as a protection layer.

The dispersion liquid of the present invention is created by dispersing a developer in a dispersion medium. The developer contains the mixture as a major component, a coloring dye, and if required, also the foregoing sensitizer and additives. For example, the dispersion liquid may be prepared by, first separately preparing a dispersion liquid containing the developer and a dispersion liquid containing a coloring dye, and then mixing these two dispersion liquids together. The sensitizer and the additives may be added to either or both of the dispersion liquid containing the developer and the dispersion liquid containing a coloring dye. Alternately, a dispersion liquid containing a sensitizer and/or additives is prepared and the two dispersion liquids respectively containing the developer and the coloring dye may be mixed with this liquid. Meanwhile, the dispersion liquid containing the developer may be created by, first adding the developer to a dispersion medium, and then dispersing the particle of the developer in the medium by milling (wet-milling) the particles until the diameter becomes 3 μm or smaller, more preferably, 1.5 μm or smaller, using a dispersing device such as a ball mill, a sand mill, an atrighter, a colloidal mill, or a sand gliding mill. The dispersion liquid containing a coloring dye and the dispersion liquid containing a sensitizer and/or additives may be created by the same method. The concentration of the developer and coloring dye in the dispersion liquid is not particularly limited and may be controlled to an arbitrary ratio however in consideration of the types of the developer, the coloring dye and the dispersion medium, the combination of these substances, and the way of applying the dispersion liquid on the supporting base. Note that, the actual preparation method of the dispersion liquid is not particularly limited.

A specific example of the supporting base may be a (high-quality) paper, a polymer film etc. Accordingly, the thermal recording material can be a thermal recording paper, such as a recording paper (output paper) used for various devices, e.g., an information communication device such as a facsimile or an information recording device such as a printer; a barcode label for POS (Point Of Sales) information management system, or various tickets and cards.

The drying method of the supporting base on which the dispersion liquid is applied, i.e., a method of forming a thermosensitive coloring layer, may be performed in any of various publicly-known methods. Further, there is no particular restriction for the application amount of the dispersion liquid per unit area of the supporting base. The thermal recording material thus created causes less texture fogging, and is superior in preservation stability. The present invention provides with such a method a thermal recording material with high coloring sensitivity, superior background whiteness, and a superior preservation stability for the colored image and the surface texture.

As described, a developer of the present invention contains 2,4′-dihydroxydiphenyl sulfone as a major component; and 4,4′-dihydroxydiphenyl sulfone, the 2,4′-dihydroxydiphenyl sulfone and the 4,4′-dihydroxydiphenyl sulfone being contained at a weight ratio greater than 90:10 and no more than 100:0, and the developer containing phenolsulfonic acid phenyl ester no more than 1.5% by weight with respect to a sum quantity of the 2,4′-dihydroxydiphenyl sulfone and the 4,4′-dihydroxydiphenyl sulfone.

Further, a developer of the present invention contains 4,4′-dihydroxydiphenyl sulfone as a major component; and 2,4′-dihydroxydiphenyl sulfone, the 4,4′-dihydroxydiphenyl sulfone and the 2,4′-dihydroxydiphenyl sulfone being contained at a weight ratio greater than 90:10 and no more than 100:0, and the developer containing phenolsulfonic acid phenyl ester no more than 1.5% by weight with respect to a sum quantity of the 4; 4′-dihydroxydiphenyl sulfone and the 2,4′-dihydroxydiphenyl sulfone.

Further, in order to solve the foregoing problem, in addition to the foregoing arrangement, the developer of the present invention contains phenolsulfonic acid phenyl ester no more than 1.0% by weight.

With the foregoing arrangement, the developer contains phenolsulfonic acid phenyl ester no more than 1.5% by weight with respect to a sum quantity of the 2,4′-dihydroxydiphenyl sulfone and the 4,4′-dihydroxydiphenyl sulfone. With this arrangement, it is possible to provide a developer suitably used as a component of a thermal recording material causing further less surface texture fogging and further superior in preservation ability.

As described, a dispersion liquid of the present invention includes the foregoing developer and a coloring dye that are dispersed in a dispersion medium. With this arrangement, it is possible to provide a dispersion liquid, that contains a developer suitably used as a component of a thermal recording material causing further less surface texture fogging and further superior in preservation ability.

As described, a thermal recording material of the present invention has a thermosensitive coloring layer that contains a developer and a coloring dye on a supporting base, wherein: the developer contains 2,4′-dihydroxydiphenyl sulfone as a major component; and 4,4′-dihydroxydiphenyl sulfone, the 2,4′-dihydroxydiphenyl sulfone and the 4,4′-dihydroxydiphenyl sulfone being contained at a weight ratio greater than 90:10 and no more than 100:0, and the developer containing phenolsulfonic acid phenyl ester no more than 1.5% by weight with respect to a sum quantity of the 2,4′-dihydroxydiphenyl sulfone and the 4,4′-dihydroxydiphenyl sulfone.

As described, a thermal recording material of the present invention has a thermosensitive coloring layer that contains a developer and a coloring dye on a supporting base, wherein: the developer contains 4,4′-dihydroxydiphenyl sulfone as a major component; and 2,4′-dihydroxydiphenyl sulfone, the 4,4′-dihydroxydiphenyl sulfone and the 2,4′-dihydroxydiphenyl sulfone being contained at a weight ratio greater than 90:10 and no more than 100:0, and the developer containing phenolsulfonic acid phenyl ester no more than 1.5% by weight with respect to a sum quantity of the 4,4′-dihydroxydiphenyl sulfone and the 2,4′-dihydroxydiphenyl sulfone.

Further, in addition to the foregoing arrangement, the thermal recording material of the present invention contains phenolsulfonic acid phenyl ester no more than 1.0% by weight.

With the foregoing arrangement, the developer contains phenolsulfonic acid phenyl ester no more than 1.5% by weight with respect to a sum quantity of the 2,4′-dihydroxydiphenyl sulfone and the 4,4′-dihydroxydiphenyl sulfone. With this arrangement, it is possible to provide a developer suitably used as a component of a thermal recording material causing further less surface texture fogging and further superior in preservation ability.

### EXAMPLES

The present invention is more specifically explained below with some concrete examples and corresponding comparative examples. However, it should be noted that the present invention is not restricted by those examples. The coloring sensitivity and the preservation stability of the thermal recording material were examined with a dynamic coloring test with respect to the colored image and the background.

[Dynamic Coloring Test]

A dynamic coloring test was performed by forming a colored image (printing section) on the thermal recording material, using a printing test machine (product of Ohkura Electric Co. Ltd.), under condition of 24V, 1.0 ms. Further, the coloring depth was measured for the colored image and the background (colorimetry) with a Macbeth reflection thermometer (RD-914).

In a thermal recording material, a greater coloring depth of the colored image indicates a superior coloring sensitivity, and a smaller coloring depth of the background indicates a superior surface whiteness. In other words, a smaller coloring depth indicates a small degree of generation of texture fogging. That is, a high value in the test indicates a superior coloring sensitivity and great preservation stability (image preservation property).

### Example 1

Firstly, a mixture of-4,4′-dihydroxydiphenyl sulfone and 2,4′-dihydroxydiphenyl sulfone was prepared through the following method. 197 g of 1,2-dichlorobenzene and 141.1 g of phenol (1.5 moles) were placed in a reactor, and then were stirred and mixed with 60.0 g (0.6 mole) of 98% sulfuric acid, which was dropped in the reactor. When all of the sulfuric acid was dropped in the reactor, the reactor was heated-up. This caused reaction, and when the contents were brought to a boil at around 148° C., water was distilled (reaction product water) with the 1,2dichlorobenzene. Then, the distillate was condensed by a condenser, and was divided into two phases by a trap. The phase of 1,2-dichlor0benzene, the lower phase of the two phases, was continuously placed back to the reactor (in the reaction system). After 6 hours since the water production first occurred, the temperature of the reaction product (contents) reached 180° C., and the water production stopped. The upper phase (water phase) separated by the trap was 22 ml. After the water production stopped, the reaction was continued for another hour.

The product resulting from the reaction was analyzed by HPLC, which showed that the product includes 4,4′-dihydroxydiphenyl sulfone, 2,4′-dihydroxydiphenyl sulfone and trihydroxytriphenyl disulfone in a weight ratio of 66:33:1.

Then, the product was cooled down to 120° C., and the deposited crystal was filtered, washed and then dried. As a result, a 78.9 g of crystal was obtained. The crystal was analyzed by HPLC, with a result that it includes 4,4′-dihydroxydiphenyl sulfone, 2,4′-dihydroxydiphenyl sulfone and trihydroxytriphenyl disulfone in a weight ratio of 95:5:0. The phenolsulfonic acid phenyl ester was not found.

In the meantime, the liquid after the extraction of crystal by filtration was heated at 120° C. to remove 1,2-dichlorobenzene and unreacted phenol, thus obtaining a 63.8 g dry solid. The dry solid was analyzed by HPLC, which showed that the solid includes 4,4′-dihydroxydiphenyl sulfone, 2,4′-dihydroxydiphenyl sulfone and trihydroxytriphenyl disulfone in a weight ratio of 17:80:3. The content of phenolsulfonic acid phenyl ester with respect to the mixture was 5.0% by weight.

Then, 128 g of water and 15.3 g of sodium hydroxide were added to the resulting dry solid, and then the solid was dissolved by heating. After processing the solid by an active carbon, 50% sulfuric acid was added by dropping at 60° C. so as to adjust the pH to 7.5. The deposited crystal was filtered, washed and dried at 60° C. As a result, a 41.0 g of crystal was obtained. The crystal was analyzed by HPLC, with a result that it includes 4,4′-dihydroxydiphenyl sulfone, 2,4′-dihydroxydiphenyl sulfone and trihydroxytriphenyl disulfone in a weight ratio of 3:97:0. The content of phenolsulfonic acid phenyl ester with respect to the mixture was 0.07% by weight. The crystal (2,4′-dihydroxydiphenyl sulfone) was used as a developer.

First, 20 g of 3-(N,N-di-n-butylamino)-6-methyl-7-anilino fluorane (coloring dye) and 100 g of 10 weight % polyvinyl alcohol aqueous solution were mixed, and then dispersed in a dispersion medium by being milled by a ball mill. Prepared was a dispersion liquid a with average particle diameter=0.8 μm.

Meanwhile, 20 g of the foregoing crystal and 100 g of 10 weight % polyvinyl alcohol aqueous solution were mixed, and then dispersed in a dispersion medium by being milled by a ball mill. Prepared was a dispersion liquid b with average particle diameter=0.8 μm.

Further, 20 g of 4-acetylbiphenyl (sensitizer) and 100 g of 10 weight % polyvinyl alcohol aqueous solution were mixed, and then dispersed in a dispersion medium while by milled by a ball mill. Prepared was a dispersion liquid c with average particle diameter=0.8 μm.

Further, the dispersion liquids a, b and c were mixed together at a ratio of 1:2:2 by weight, to create 200 g of mixture liquid. Then, 50 g of calcium carbonate (white pigment) was added and dispersed in the mixture liquid, thus preparing a dispersion liquid for forming a thermosensitive coloring layer.

The dispersion liquid was applied to a high-quality paper (supporting base) to form a thermosensitive coloring layer. The process was performed with a control of the amount of the liquid so that the application amount on the paper is 6 g/m² when the liquid is dried. Consequently, the thermal recording paper (thermal recording material) of the present invention was obtained.

The created thermal recording paper was subjected to the foregoing test. Table 1 shows the results. As shown therein, the thermal recording paper had high coloring sensitivity, and was superior in surface whiteness and preservation stability for both the colored image and the background.

### Comparative Example 1

Then, as with Example 1, 128 g of water and 15.3 g of sodium hydroxide were added to the dry solid, and then the solid was dissolved by heating. After processing the solid by an active carbon, 50% sulfuric acid was added by dropping at 60° C. so as to adjust the pH to 7.5. The deposited crystal was cooled down to 40° C., and then was filtered, washed and dried. As a result, a 42.0 g of crystal was obtained. The crystal was analyzed by HPLC, with a result that it includes 4,4′-dihydroxydiphenyl sulfone, 2,4′-dihydroxydiphenyl sulfone and trihydroxytriphenyl disulfone in a weight ratio of 5:95:0. The content of phenolsulfonic acid phenyl ester with respect to the mixture was 3.0% by weight.

Then, the same processes for producing a thermal recording paper as those of Example 1, except for the use of the foregoing crystal (2,4′-dihydroxydiphenyl sulfone) as a comparative example, were performed, and the resulting thermal recording paper was subjected to the foregoing test. Table 1 shows the results. With the comparative developer, the background of the paper has a large coloring depth. Accordingly, this developer is significantly poor in quality compared to the developer of Example 1.

### Example 2

The same processes for producing a thermal recording paper as those of Example 1, except for the use of a developer made of the foregoing crystal of 4,4′-dihydroxydiphenyl sulfone (95 weight % pure) that was separated by filtration from the reaction liquid obtained in Example 1, were performed, and the resulting thermal recording paper was subjected to the foregoing test. Table 1 shows the results.

TABLE 1

DYNAMIC COLORING TEST

| | BACKGROUND | COLORED IMAGE |
|---|---|---|
| EXAMPLE 1 | 0.06 | 1.05 |
| COMPARATIVE | 0.16 | 1.05 |
| EXAMPLE 1 | | |
| EXAMPLE 2 | 0.07 | 1.00 |

It should be noted that the embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The present invention is useful for a developer and a thermal recording material.

1. A developer which contains 2,4′-dihydroxydiphenyl sulfone as a major component; and 4,4′-dihydroxydiphenyl sulfone, the 2,4′-dihydroxydiphenyl sulfone and the 4,4′-dihydroxydiphenyl sulfone being contained at a weight ratio greater than 90:10 and no more than 100:0, and
the developer containing phenolsulfonic acid phenyl_ester no more than 1.5% by weight with respect to a sum quantity of the 2,4′-dihydroxydiphenyl sulfone and the 4,4′-dihydroxydiphenyl sulfone.

2. A developer which contains 4,4′-dihydroxydiphenyl sulfone as a major component; and 2,4′-dihydroxydiphenyl sulfone, the 4,4′-dihydroxydiphenyl sulfone and the 2,4′-dihydroxydiphenyl sulfone being contained at a weight ratio greater than 90:10 and no more than 100:0, and
the developer containing phenolsulfonic acid phenyl_ester no more than 1.5% by weight with respect to a sum quantity of the 4,4′-dihydroxydiphenyl sulfone and the 2,4′-dihydroxydiphenyl sulfone.

3. The developer as set forth in claim 1, wherein:
the developer containing phenolsulfonic acid phenyl_ester no more than 1.0% by weight.

4. A dispersion liquid in which the developer as set forth claim 1, and a coloring dye are dispersed in a dispersion medium.

5. A thermal recording material having a thermosensitive coloring layer that contains a developer and a coloring dye on a supporting base,
wherein:
the developer contains 2,4′-dihydroxydiphenyl sulfone as a major component; and 4,4′-dihydroxydiphenyl sulfone, the 2,4′-dihydroxydiphenyl sulfone and the 4,4′-dihydroxydiphenyl sulfone being contained at a weight ratio greater than 90:10 and no more than 100:0, and
the developer containing phenolsulfonic acid phenyl_ester no more than 1.5% by weight with respect to a sum quantity of the 2,4′-dihydroxydiphenyl sulfone and the 4,4′-dihydroxydiphenyl sulfone.

6. A thermal recording material including a thermosensitive coloring layer that contains a developer and a coloring dye on a supporting base,
wherein:
the developer contains 4,4′-dihydroxydiphenyl sulfone as a major component; and 2,4′-dihydroxydiphenyl sulfone, the 4,4′-dihydroxydiphenyl sulfone and the 2,4′-dihydroxydiphenyl sulfone being contained at a weight ratio greater than 90:10 and no more than 100:0, and
the developer containing phenolsulfonic acid phenyl ester no more than 1.5% by weight with respect to a sum quantity of the 4,4′-dihydroxydiphenyl sulfone and the 2,4′-dihydroxydiphenyl sulfone.

7. The thermal recording material as set forth in claim 5, wherein:
the developer containing phenolsulfonic acid phenyl ester no more than 1.0% by weight.

8. The developer as set forth in claim 2, wherein:
the developer containing phenolsulfonic acid phenyl ester no more than 1.0% by weight.

9. A dispersion liquid in which the developer as set forth in claim 2, and a coloring dye are dispersed in a dispersion medium.

10. A dispersion liquid in which the developer as set forth in claim 3, and a coloring dye are dispersed in a dispersion medium.

11. A dispersion liquid in which the developer as set forth in claim 8, and a coloring dye are dispersed in a dispersion medium.

12. The thermal recording material as set forth in claim 6, wherein:
the developer containing phenolsulfonic acid phenyl ester no more than 1.0% by weight.
